(19) United States
(12) Patent Application Publication
(10) Pub. No.: US 2025/0168749 A1
(43) Pub. Date: May 22, 2025

(54) System and Method for Passive Scanning with a Secondary Beacon Interface

(71) Applicant: ZEBRA TECHNOLOGIES CORPORATION, Lincolnshire, IL (US)

(72) Inventors: Venkata Aneel Kumar Inuganti, Bangalore (IN); Mahesh Kumar Edar, Davenagere (IN); Darpan Majumder, Bangalore (IN)

(21) Appl. No.: 18/513,205

(22) Filed: Nov. 17, 2023

(51) Int. Cl. H04W 48/10; H04W 48/16

(52) U.S. Cl. CPC H04W 48/10; H04W 48/16

(57) ABSTRACT

An example computing device includes: a communications interface configured to connect to a network deployed by a plurality of base stations; a controller for the communications interface, the controller configured to: in response to a scan condition, select a foreign channel to scan, the foreign channel having a corresponding foreign base station configured to emit a beacon signal; broadcast a scan initiation notification to prompt a secondary device connected on the foreign channel to emit a secondary beacon signal; move to the selected foreign channel; detect one of: the beacon signal and the secondary beacon signal to identify the foreign base station; and in response to identifying the foreign base station, return to a home channel.

### BACKGROUND

Wireless networks may be serviced by several access points to which mobile devices can connect based on their location within the wireless network. As users of mobile devices move around, the mobile devices may roam to different access points. When connecting to an access point or roaming between access points, the device may perform a scan to identify potential access points by performing channel scans to detect access points operating on a given channel. However, such channel scans require the device to move away from the home access point channel for the duration of the scan, which may cause packets to be dropped from ongoing communications.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for passive scanning with a secondary beacon interface.

FIG. 2 is a block diagram of certain internal hardware components of certain devices of FIG. 1.

FIG. 3 is a flowchart of an example method of passive scanning with a prompt for support from a secondary beacon interface.

FIG. 4 is a schematic diagram of an example performance of block 320 of the method of FIG. 3.

FIG. 5 is a flowchart of an example method of supporting a passive scanning operation by a secondary beacon interface.

FIG. 6 is a schematic diagram of an example performance of block 520 of the method of FIG. 5.

FIG. 7 is a schematic diagram of another example performance of block 520 of the method of FIG. 5.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a device comprising: a communications interface configured to connect to a network deployed by a plurality of base stations; a controller for the communications interface, the controller configured to: in response to a scan condition, select a foreign channel to scan, the foreign channel having a corresponding foreign base station configured to emit a beacon signal; broadcast a scan initiation notification to prompt a secondary device connected on the foreign channel to emit a secondary beacon signal; move to the selected foreign channel; detect one of: the beacon signal and the secondary beacon signal to identify the foreign base station; and in response to identifying the foreign base station, return to a home channel.

Additional examples disclosed herein are directed to a device comprising: a communications interface configured to connect to a network deployed by a plurality of base stations; a controller for the communications interface, the controller configured to: receive a scan initiation notification from a scanning device; in response to the scan initiation notification, determine whether an operating channel of the computing device is a passive scanning channel; and when the operating channel is the passive scanning channel, emit a secondary beacon signal, the secondary beacon signal offset from a beacon signal emitted by a home base station for the operating channel.

Additional examples disclosed herein are directed to a method comprising: detecting a scan condition; in response to detecting the scan condition, selecting a foreign channel to scan, the foreign channel having a corresponding foreign base station configured to emit a beacon signal; broadcasting a scan initiation notification to prompt a secondary device connected on the foreign channel to emit a secondary beacon signal; moving to the selected foreign channel; detecting one of: the beacon signal and the secondary beacon signal to identify the foreign base station; and in response to identifying the foreign base station, returning to a home base station.

Additional examples disclosed herein are directed to a method comprising: receiving a scan initiation notification from a scanning device; in response to receiving the scan initiation notification, determining whether an operating channel of the computing device is a passive scanning channel; and when the operating channel is a passive scanning channel, emitting a secondary beacon signal offset from a beacon signal emitted by a home base station for the operating channel.

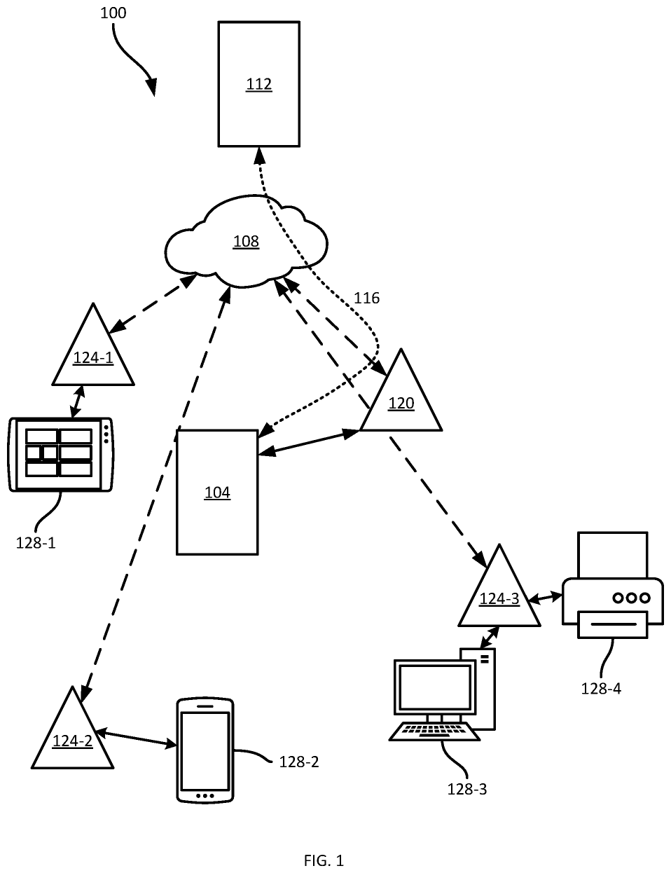

FIG. 1 depicts a system 100 for passive scanning with a secondary beacon interface in accordance with the teachings of this disclosure. The system 100 includes a computing device 104 (also referred to herein as simply the device 104) connected to a network 108. The device 104 may communicate with a second computing device 112 (also referred to herein as the peer device 112) via a link 116 which traverses the network 108. In some examples, the device 112 may be remote from the device 104 and the link 116 may therefore additionally traverse one or more wide-area networks such as the Internet, mobile networks and the like.

The device 104 may be a mobile computing device such as a handheld computer, a mobile phone, a tablet, a barcode scanner or the like. As noted above, the device 104 is connected to the network 108, which may be deployed for wireless communications within a facility, such as a transportations and logistics facility, a warehouse, retail establishment, or other facility. Accordingly, the network 108 may be a wireless local area network (WLAN) and/or a wireless wide area network (WWAN) deployed by one or more base stations, including without limitation one or more access points and/or cellular base stations, citizens broadband radio service (CBRS) base stations, or the like. In the present example, four access points, a home access point 120, and three foreign access points 124-1, 124-2, and 124-3 (referred to herein generically as an access point 124 and collectively as access points 124; this nomenclature is also used elsewhere herein) are depicted. In other examples, the network 108 may include more or fewer access points.

In particular, the device 104 may be currently serviced by the home access point 120 to connect to the network 108. Since the device 104 may be mobile, the device 104 may be carried about by a user. As the user of the device 104 moves about the facility or other region serviced by the network 108, the connection of the device 104 to the home access point 120 may weaken, and the device 104 may be better serviced by another foreign access point 124 of the network 108. Accordingly, the device 104 may scan the foreign access points 124 and may subsequently roam to one of the foreign access points 124 to connect to the network 108, for example when the device 104 is out of range of the home access point 120 and/or when a better connection may be achieved via one of the foreign access points 124.

To identify the foreign access points 124, the device 104 performs an access point scan. During the access point scan, the device 104 may perform multiple channel scans for each of a plurality of channels to identify access points 124 operating on a given channel. Together, the set of channel scans form the access point scan. During each of the channel scans, the device 104 moves away from its current operating channel with the home access point 120, so ongoing communications (e.g., between the device 104 and the device 112) may be buffered until the device 104 returns to the operating channel of the home access point 120.

To reduce the amount of time spent away from the home access point 120 while performing a channel scan on a foreign channel, the device 104 may return to the home access point 120 as soon as the device 104 identifies the corresponding foreign access point 124 operating on the foreign channel.

Wireless communications operating standards may specify that some types of channels, such as dynamic frequency selection (DFS) channels, are restricted. Specifically, scans on DFS channels are restricted to passive scans until activity is detected on a DFS channel prior to switching to an active scans. That is, scanning devices are configured to passively wait for detection of a beacon signal emitted periodically by an access point operating on the DFS channel. Accordingly, DFS scans may take up to 100 ms (or some other predetermined default scan time) to complete depending on the time at which the passive scan was initiated. This length of time increases the chances of dropping packets while the device 104 is away from the home access point during each channel scan.

Thus, in accordance with the present disclosure, upon detecting that the channel for an upcoming channel scan is a DFS channel or another type of channel requiring an initial passive scan, the device 104 may first broadcast a scan initiation notification. In particular, the scan initiation notification may be broadcasted via another communications protocol, such as Bluetooth Low Energy. The scan initiation notification may prompt nearby secondary devices, and in particular, nearby secondary devices connected to DFS channels, to begin acting as secondary beacon sources.

For example, FIG. 1 depicts secondary computing devices 128-1, 128-2, and 128-3, and 128-4 connected to access points 124-1, 124-2, 124-3, and 124-3, respectively. The computing devices 128 may be computing devices such as printers, laptops, desktop computers, fixed workstations, other mobile computing devices, such as scanners, tablets, mobile phones, or the like. Upon receiving a scan initiation notification from the scanning device 104, if the channels on which the corresponding access points 124 are operating are DFS channels, the secondary computing devices 128 may begin emitting secondary beacon signals containing identifying data for the corresponding access point 124. In particular, the secondary computing device 128 may emit the secondary beacon signal offset from the beacon signal, such as at a midpoint of the interval at which the beacon signal is emitted. Thus, the device 104 may detect either the beacon signal or the secondary beacon signal within a period of at most half of the interval at which the beacon signal is emitted, and the duration of the channel scan may be reduced.

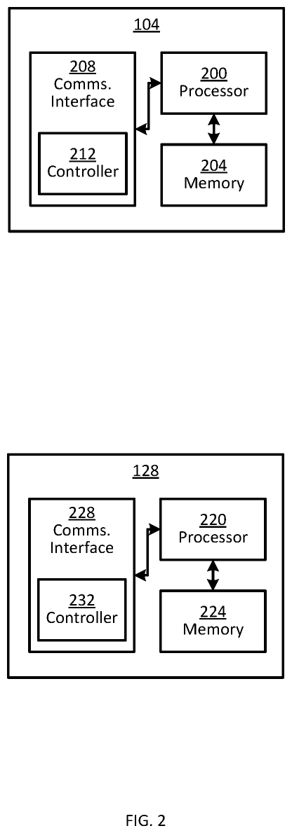

Turning now to FIG. 2, certain internal components of the computing device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes a communications interface 208 enabling the device 104 to exchange data with other computing devices, such as the device 112. The communications interface 208 is interconnected with the processor 200. The communications interface 208 includes a controller 212, and one or more antennas, transmitters, receivers, or the like (not shown), to allow the device 104 to communicate with other computing devices such as the device 112 over the network 108 via the link 116. The communications interface 208 may further allow the device 104 to communicate with (e.g., to broadcast signals, via a two-way communication link, etc.) other computing devices such as the devices 128 according to a secondary communications protocol, such as a Bluetooth Low Energy protocol or other suitable wireless transmission protocol.

The controller 212 may be a micro-controller, a micro-processor, or other suitable device capable of executing computer-readable instructions to control the components, such as the antennae, transmitters, receivers, and the like, of the communications interface 208 to perform the functionality described herein. The controller 212 may comprise one or more integrated circuits and may include and/or be interconnected with a non-transitory computer-readable storage medium storing computer-readable instructions which when executed configure the controller 212 and/or the communications interface 208 to perform the functionality described herein. In particular, the controller 212 may control a passive scanning operation with a prompt for support from a secondary beacon interface.

The device 104 may further include one or more input and/or output devices (not shown) suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

Certain internal components of a computing device 128 is also shown in FIG. 2. The computing device 128 includes a processor 220 interconnected with a non-transitory computer-readable storage medium, such as a memory 224. The processor 220 and the memory 204 may each comprise one or more integrated circuits. The memory 224 stores computer-readable instructions for execution by the processor 220, including one or more applications which, when executed, configure the processor 220 to perform the various functions of the device 128.

The device 128 further includes a communications interface 228 enabling the device 128 to connect to one of the access points 124 to communicate with other devices via the network 108. The communications interface 228 includes a controller 232, and one or more antennas, transmitters, receivers, or the like (not shown), to allow the device 104 to communicate with other computing devices. The communications interface 228 further allows communications with (e.g., to receive signals from, via a two-way communications link, etc.) the device 104 via a secondary communications protocol, such as Bluetooth Low Energy.

The controller 232 may be a micro-controller, a micro-processor, or other suitable device capable of executing computer-readable instructions to control the components of the communications interface 228 to perform the functionality described herein. The controller 232 may comprise one or more integrated circuits and may include and/or be interconnected with a non-transitory computer-readable storage medium storing computer-readable instructions which when executed configure the controller 232 and/or the communications interface 228 to perform the functionality described herein. In particular, the controller 232 may control a scanning support operation, wherein the device 128 supports a scanning operation by a scanning device by acting as a secondary beacon interface.

The device 128-1 may further include one or more input and/or output devices (not shown) suitable to allow an operator to interact with the device 128-1. The input devices may include one or more buttons, keypads, touch-sensitive display screens or the like for receiving input from an operator. The output devices may further include one or more display screens, sound generators, vibrators, or the like for providing output or feedback to an operator.

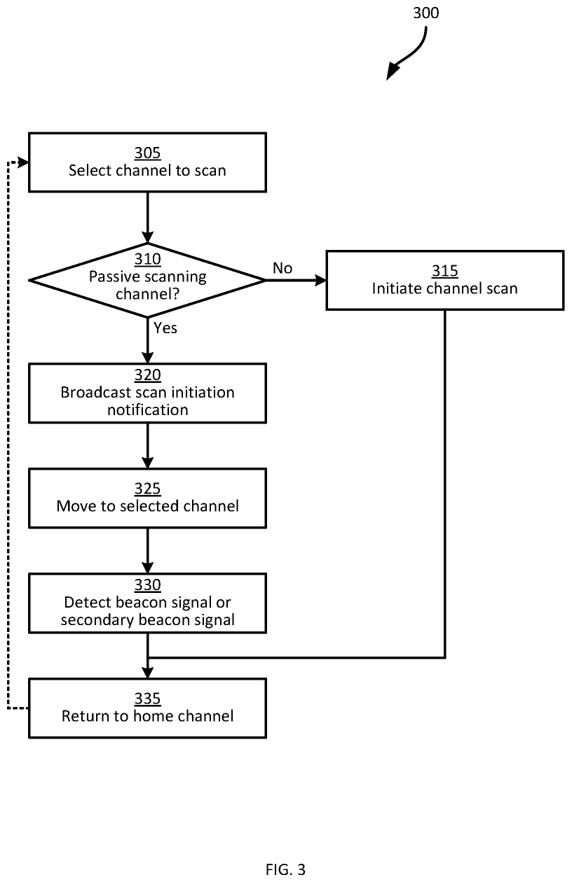

Turning now to FIG. 3, the functionality implemented by the device 104 will be discussed in greater detail. FIG. 3 illustrates a method 300 of performing a scanning operation, and in particular, a passive scanning operation with a request for support by a secondary beacon interface. The method 300 will be discussed in conjunction with its performance in the system 100, and particularly by the device 104. In particular, the method 300 will be described with reference to the components of FIGS. 1 and 2. In other examples, the method 300 may be performed by other suitable devices or systems.

The method 300 is initiated at block 305, for example in response to the device 104 detecting a scan condition to initiate an access point scan. For example, the device 104 may detect that a signal strength to the home access point 120 is below a threshold strength, that a quality of service (e.g., as determined based on jitter, latency, etc.) is below a predetermined threshold, or other similar condition. As a result, the device 104 may initiate the access point for foreign access points 124. To perform the access point scan, the device 104 may perform a series of channel scans on a set of foreign channels. Accordingly, at block 305, the device 104 may further be configured to select a foreign channel to scan from the set of foreign channels. In particular, the device 104 may track which foreign channels have been scanned and select a foreign channel which has not yet been scanned.

At block 310, the device 104 determines whether the selected foreign channel is a channel on which the device 104 is configured to perform a passive scan to detect a beacon signal emitted from the corresponding foreign access point 124 which operates on the selected foreign channel. For example, if the selected foreign channel is a DFS-type channel, then the device 104 may make an affirmative determination at block 310. In other examples, other types of channel and/or other factors may contribute to an affirmative determination at block 310.

If the determination at block 310 is negative, then the device 104 proceeds to block 315 to initiate a channel scan at the selected foreign channel. For example, the channel scan may include an active scan, such as by broadcasting an active query for a response by the foreign access point 124.

If the determination at block 310 is affirmative, then the device 104 proceeds to block 320. At block 320, the device 104 is configured to broadcast a scan initiation notification to notify nearby devices, such as the devices 128, that the device 104 will shortly initiate a channel scan. The scan initiation notification may be broadcast on via a secondary communications protocol, such as via Bluetooth Low Energy. In particular, the scan initiation notification may be sent directly to the devices 128, rather than via the network 108.

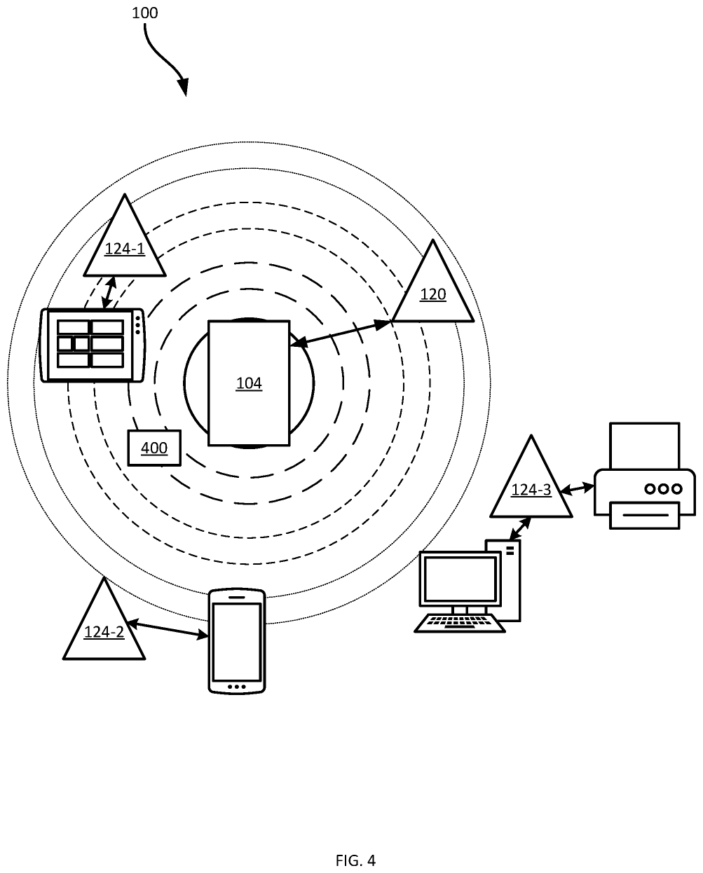

For example, referring to FIG. 4, a schematic diagram of an example performance of block 320 is depicted. The device 104 may broadcast a scan initiation notification 400 to be received by any secondary devices 128 within the broadcast range of the device 104. The scan initiation notification 400 is configured to prompt the secondary devices 128 to emit secondary beacon signals, as appropriate, on the respective foreign channels, as will be described further below. In some examples, the scan initiation notification 400 may include an identifier of the foreign channel selected at block 305 to reduce the wireless transmission traffic in the area.

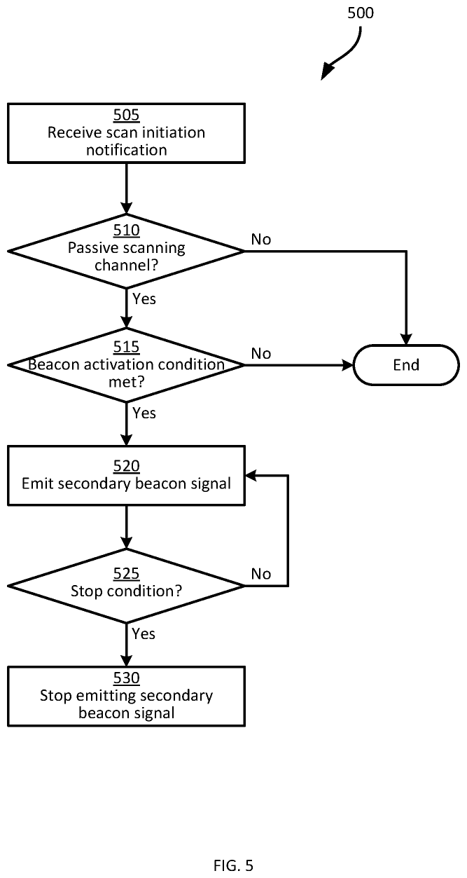

For example, referring to FIG. 5, a flowchart of an example method 500 of emitting a secondary beacon signal to support a scanning operation of a nearby scanning device is depicted. The method 500 will be described below in conjunction with its performance by one of the computing devices 128. In other examples, the method 500 may be performed by other suitable devices or systems.

The method 500 is initiated at block 505, where the computing device 128 receives a scan initiation notification from a scanning device. For example, the computing device 128 may receive the scan initiation notification 400 from the device 104.

At block 510, the computing device 128 determines whether an operating channel for the device 128 is a passive scanning channel, such as a DFS channel. In particular, while the scan initiation notification may be broadcasted when the scanning device is scanning a passive scanning channel, since the scan initiation notification may be broadcasted via a secondary communications protocol, the scan initiation notification may be received by nearby computing devices 128 which do not operate on a passive scanning channel. Accordingly, the device 128 may determine at block 510 whether it is appropriate to act as a secondary beacon interface, based on the type of channel (or other channel properties) which the device 128 operates on.

If the determination at block 510 is negative, that is, the computing device 128 and the corresponding foreign access point 124 do not operate on a passive scanning channel, then the computing device 128 may proceed to end the performance of the method 500.

If the determination at block 510 is affirmative, that is the computing device 128 and the corresponding foreign access point 124 operate on a passive scanning channel, then the computing device 128 proceeds to block 515. At block 515, the device 128 determines whether a beacon activation condition is met. That is, the device 128 may determine whether it is appropriate to act as a secondary beacon interface, based on parameters related to the scanning device (e.g., the device 104).

For example, the beacon activation condition may include determining whether a signal strength of the scan initiation notification received from the scanning device exceeds a predefined threshold strength. That is, the device 128 may determine, based on the signal strength of the scan initiation notification, whether the scanning device is expected to be sufficiently close to the device 128 that a secondary signal from the device 128 would likely be received by the scanning device.

For example, referring to the schematic diagram shown in FIG. 4, according to a first example, if the access points 124-1 and 124-3 operate on DFS-type or other passive scanning-type channels, then the devices 128-1, 128-3, and 128-4 may make an affirmative determination at block 510, while the device 128-2 may make a negative determination at block 510, after receiving the scan initiation notification. Further, at block 515, the devices 128-1 and 128-3 may make an affirmative determination as having a signal strength of the scan initiation notification 400 exceed a predefined threshold strength. The device 128-4 may still receive the scan initiation notification 400, but may make a negative determination at block 510. In other examples, for example, if the predefined threshold strength is higher, only the device 128-1 may make an affirmative determination at block 510.

In other examples, the beacon activation condition may be based on a channel identifier included in the scan initiation notification. In particular, the channel identifier may identify a particular channel which the scanning device has selected to scan. Accordingly, the device 128 may determine whether the channel identifier matches the channel on which the device 128 and the corresponding foreign access point 124 are operating. Thus, only devices 128 which are connected to the channel to be scanned by the scanning device may broadcast secondary beacon signals to further reduce wireless transmission traffic in the area.

Thus, according to another example, the scan initiation notification 400 may include a channel identifier (not shown) for the channel associated with access point 124-3, for example. Accordingly, in this example, the devices 128-3 and 128-4 may make an affirmative determination at block 510, while the device 128-1 makes a negative determination at block 510.

In still further examples, the beacon activation condition may include combinations of the above conditions, or other suitable conditions based on other parameters related to the scanning device.

Returning to FIG. 5, if the determination at block 515 is negative, that is, the beacon activation condition is not met, then the device 128 proceeds to end the performance of the method 500.

If the determination at block 515 is affirmative, that is, the beacon activation condition is met, then the device 128 proceeds to block 520. At block 520, the device 128 is configured to emit a secondary beacon signal offset from the beacon signal emitted by the corresponding foreign access point 124. For example, the device 128 may obtain or determine a beacon signal pattern or interval of the beacon signal emitted by the corresponding access point 124. The device 128 may determine a schedule on which to emit a secondary beacon signal which is offset from the beacon signal emitted by the access point 124. In particular, offsetting the secondary beacon signal from the beacon signal may reduce the time period for the scanning to device to receive one of the beacon signal or the secondary beacon signal. For example, the secondary beacon signal may be emitted at a midpoint of the beacon interval at which the beacon signal is emitted by the access point 124. The secondary beacon signal may contain the same or similar identifying information as the beacon signal to allow the scanning device to identify the access point 124.

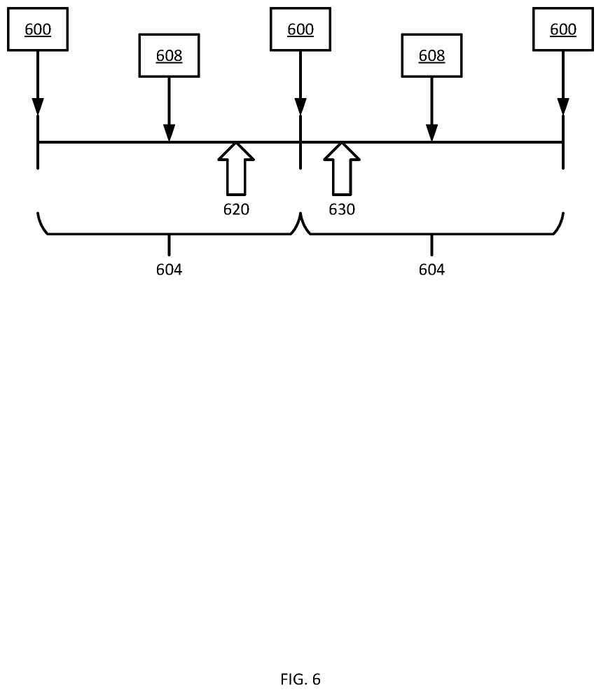

For example, referring to FIG. 6, the device 128-1 may determine that the access point 124-1 emits beacon signals 600 at a beacon interval 604. Accordingly, the device 128-1 may emit secondary beacon signals 608 at a midpoint of the beacon interval 604, and any subsequent iterations of the beacon interval 604. Thus, if the device 104 emits the scan initiation notification 400 and moves to the channel of the access point 124-1 at a point 620, near the end of the beacon interval 604, then the device 104 may detect a beacon signal 600 emitted by the access point 124-1 shortly thereafter. If the device 104-1 emits the scan notification 400 and moves to the channel of the access point 124-1 at a point 630, near the beginning of the beacon interval 604, then the device 104 may detect a secondary beacon signal 608 emitted by the device 128-1 at the midpoint of beacon interval 604 rather than waiting for the rest of the beacon interval 604 to elapse. Thus, the length of time which the device 104 has to wait to receive one of the beacon signal 600 or the secondary beacon signal 608 may be shortened to at most one half of the original beacon interval 604.

In some examples, at block 520 of the method 500, if further computing devices 128 are also connected on the same channel, then the device 128 may coordinate with the further computing devices to emit a further beacon signal, such that each of the beacon signal, the secondary beacon signal and the further beacon signal are each offset from one another.

For example, the device 128 may identify any further computing devices connected on the operating channel, and determine the total number of interfaces (e.g., including the access point 124, the device 128 and any further devices 128 connected on the channel). The device 128 may divide the beacon interval into a number of portions (e.g., equally sized portions) corresponding to the number of interfaces. The access point 124 is configured to emit beacon signals at the beginning of each beacon interval. Accordingly, the device 128 may coordinate with the further devices 128 to emit secondary beacon signals at each of the boundaries between the portions of the intervals.

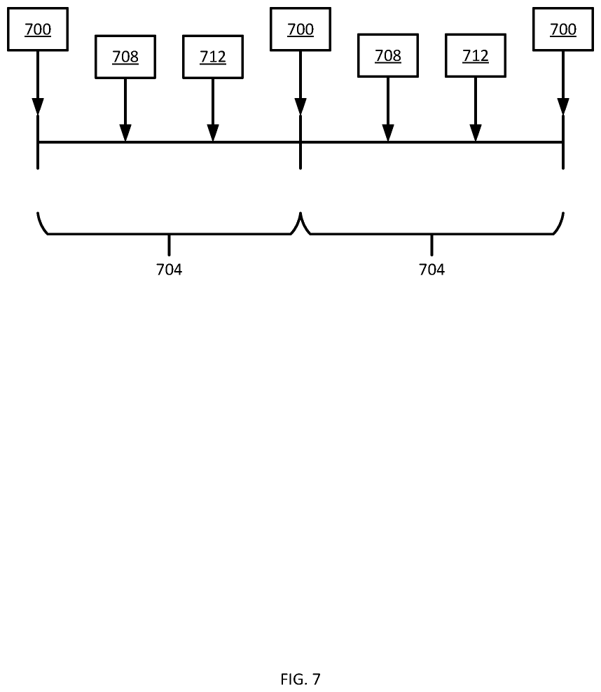

For example, referring to FIG. 7, each of the devices 128-3 and 128-4 may determine that they are to emit secondary beacon signals. From the perspective of the device 128-3, for example, the device 128-3 may determine that the access point 124-3 emits beacon signals 700 at a beacon interval 704.

The device 128-3 may further identify the device 128-4 as a further computing device connected on the operating channel of the access point 124-3. The device 128-3 may then coordinate with the device 128-4 to determine suitable times at which (a) the device 128-3 should emit a secondary beacon signal and (b) the device 128-4 should emit another secondary beacon signal. In particular the suitable times may space the beacon signal emitted by the access point 124-3, the secondary beacon signal emitted by the device 128-3, and the secondary beacon signal emitted by the device 128-4 equally in time over the beacon interval 704. Thus, for example, the device 128-3 may emit a secondary beacon signal 708 at a one-third mark of the beacon interval 704, while the device 128-4 may emit a secondary beacon signal 712 at a two-thirds mark of the beacon interval 704. The length of time which the device 104 has to wait to receive one of the beacon signal 700, the secondary beacon signal 708 or the secondary beacon signal 712 may thus be shortened to at most one third of the original beacon interval 704.

Accordingly, returning now to FIG. 3, after broadcasting the scan initiation notification to prompt one or more secondary devices to act as secondary beacon interface at block 320, the device 104 proceeds to block 325. At block 325, the device 104 moves from the home channel corresponding to the home access point 120 to the foreign channel selected at block 305. The device 104 may further initiate a channel scan on the selected foreign channel. For example, the device 104 may initiate a passive scan to receive beacon signals emitted on the selected foreign channel.

At block 330, the device 104 detects the beacon signal emitted by the foreign access point 124 corresponding to the selected foreign channel or a secondary beacon signal emitted by one of the computing devices 128 acting as a secondary beacon interface. The device 104 may use the beacon signal or the secondary beacon signal to identify the foreign access point 124. In some examples, upon receiving the beacon signal or the secondary beacon signal, the device 104 may switch from a passive scan to an active scan to complete the identification of the foreign access point 124 prior to proceeding to block 335.

At block 335, after identifying the foreign access point 124 corresponding to the foreign channel, the device 104 returns to the home access point 120 and may receive data packets buffered at the home access point 120 during the channel scan. In particular, when a nearby device 128 is able to act as a secondary beacon interface on a passive scanning channel, the duration of the channel scan may be shortened from the regular beacon interval by up to half, thereby reducing the likelihood of dropped packets when the device 104 returns to the home access point 120 to receive the buffered packets. This may increase the quality of communications, particularly for ongoing, real-time communications such as a voice call or the like.

In some examples, at block 335, the device 104 may additionally broadcast a scan termination notification to notify nearby devices 128 acting as a secondary beacon interface that the scan has been terminated and that the devices 128 may stop secondary beacon operations. The scan termination notification may be sent via a secondary communications protocol, such as Bluetooth Low Energy or the like. The device 104 may then optionally return to block 305 to select another channel to scan to complete the access point scan. Alternately, if the access point scan is complete, the device 104 may process the results of the access point scan, for example by selecting a foreign access point 124 to connect to and roaming to the selected foreign access point 124.

Returning again to FIG. 5, after emitting the secondary beacon signal at block 520, the device 128 is configured to proceed to block 525. At block 525, the device 128 determines whether a stop condition is detected. For example, the stop condition may include receiving the scan termination notification from the scanning device, or expiry of a predefined beaconing duration. For example, a beacon timer may be initiated at block 520 prior to emitting the secondary beacon signal. In some examples, the beacon timer may be reset or re-initiated if the device 128 receives another scan initiation notification, for example from a different scanning device. Other suitable stop conditions are also contemplated.

If, at block 525, no stop condition is detected, then the device 128 returns to block 520 to continue emitting secondary beacon signals offset from the beacon signal emitted by the foreign access point 124.

If, at block 525, a stop condition is detected, then the device 128 proceeds to block 530, where the device 128 stops emitting the secondary beacon signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device comprising:
a communications interface configured to connect to a network deployed by a plurality of base stations;
a controller for the communications interface, the controller configured to:
in response to a scan condition, select a foreign channel to scan, the foreign channel having a corresponding foreign base station configured to emit a beacon signal;
broadcast a scan initiation notification to prompt a secondary device connected on the foreign channel to emit a secondary beacon signal;
move to the selected foreign channel;
detect one of: the beacon signal and the secondary beacon signal to identify the foreign base station; and
in response to identifying the foreign base station, return to a home channel.

2. The computing device of claim 1, wherein the scan initiation notification includes an identifier of the selected foreign channel.

3. The computing device of claim 1, wherein the controller is further configured to, after returning to the home channel, broadcast a scan termination notification.

4. The computing device of claim 1, wherein the controller is configured to broadcast the scan initiation notification via a secondary communications protocol.

5. A computing device comprising:
a communications interface configured to connect to a network deployed by a plurality of base stations;
a controller for the communications interface, the controller configured to:
receive a scan initiation notification from a scanning device;
in response to the scan initiation notification, determine whether an operating channel of the computing device is a passive scanning channel; and
when the operating channel is the passive scanning channel, emit a secondary beacon signal, the secondary beacon signal offset from a beacon signal emitted by a home base station for the operating channel.

6. The computing device of claim 5, wherein the scan initiation notification is received via a secondary communications protocol.

7. The computing device of claim 5, wherein the controller is configured to:
determine whether a beacon activation condition is met; and
emit the secondary beacon signal when the beacon activation condition is met.

8. The computing device of claim 7, wherein the beacon activation condition comprises one or more of:
determining that a signal strength of the scan initiation notification received from the scanning device is above a threshold strength; and
determining that the home base station operates on a channel corresponding to a channel identifier included in the scan initiation notification.

9. The computing device of claim 5, wherein the controller is further configured to:
identify a further computing device connected on the operating channel; and
coordinate with the further computing device to emit a further secondary beacon signal, such that each of the beacon signal, the secondary beacon signal and the further secondary beacon signal are offset.

10. The computing device of claim 5, wherein the controller is configured to, in response to detecting a stop condition, stop emitting the secondary beacon signal.

11. The computing device of claim 10, wherein the stop condition comprises one or more of:
receiving a scan termination notification from the scanning device; and
expiry of a predefined beaconing duration.

12. A method comprising:
detecting a scan condition;
in response to detecting the scan condition, selecting a foreign channel to scan, the foreign channel having a corresponding foreign base station configured to emit a beacon signal;
broadcasting a scan initiation notification to prompt a secondary device connected on the foreign channel to emit a secondary beacon signal;
moving to the selected foreign channel;
detecting one of: the beacon signal and the secondary beacon signal to identify the foreign base station; and
in response to identifying the foreign base station, returning to a home channel.

13. The method of claim 12, wherein the scan initiation notification includes an identifier of the selected foreign channel.

14. The method of claim 12, further comprising, after returning to the home base station, broadcasting a scan termination notification.

15. The method of claim 12, comprising broadcasting the scan initiation notification via a secondary communications protocol.

16. A method comprising:
receiving a scan initiation notification from a scanning device;
in response to receiving the scan initiation notification, determining whether an operating channel is a passive scanning channel; and
when the operating channel is the passive scanning channel, emitting a secondary beacon signal offset from a beacon signal emitted by a home base station for the operating channel.

17. The method of claim 16, wherein the scan initiation notification is received via a secondary communications protocol.

18. The method of claim 16, further comprising:
determining whether a beacon activation condition is met; and
emitting the secondary beacon signal when the beacon activation condition is met.

19. The method of claim 18, wherein the beacon activation condition comprises one or more of:
determining that a signal strength of the scan initiation notification received from the scanning device is above a threshold strength; and
determining that the home base station operates on a channel corresponding to a channel identifier included in the scan initiation notification.

20. The method of claim 16, further comprising:
identifying a further computing device connected on the operating channel; and
coordinating with the further computing device to emit a further secondary beacon signal, such that each of the beacon signal, the secondary beacon signal and the further secondary beacon signal are offset.

21. The method of claim 16, further comprising, in response to detecting a stop condition, stopping emission of the secondary beacon signal.

22. The method of claim 21, wherein the stop condition comprises one or more of:
receiving a scan termination notification from the scanning device; and
expiry of a predefined beaconing duration.
